(19) United States
(12) Patent Application Publication
(10) Pub. No.: US 2018/0029017 A1
(43) Pub. Date: Feb. 1, 2018

(54) PHOTOCATALYTIC FILTER FOR DEGRADING MIXED GAS AND MANUFACTURING METHOD THEREOF

(71) Applicant: Seoul Viosys Co., Ltd., Ansan-si (KR)

(72) Inventors: Jaeseon Yi, Seoul (KR); Daewoong Suh, Seoul (KR); Geundo Cho, Ansan-si (KR); Doug Youn Lee, Ansan-si (KR); Hye Kyung Ku, Ansan-si (KR); Kyung Sik Yoon, Ansan-si (KR); JiWon Kim, Ansan-si (KR); JaeHak Jeong, Ansan-si (KR)

(21) Appl. No.: 15/687,335

(22) Filed: Aug. 25, 2017

Related U.S. Application Data
(63) Continuation-in-part of application No. 14/871,932, filed on Sep. 30, 2015.
(60) Provisional application No. 62/057,794, filed on Sep. 30, 2014.

(30) Foreign Application Priority Data
Mar. 4, 2015 (CN) 201510096590.7

(51) Int. Cl. B01J 23/888; B01J 35/00; B01D 53/88; B01J 37/02; B01J 37/08; B01D 53/86; B01J 21/06; B01J 35/04

(52) U.S. Cl. CPC B01J 23/888; B01J 21/063; B01J 35/004; B01J 35/04; B01J 37/0215; B01J 37/0236; B01J 37/08; B01D 53/8634; B01D 53/8668; B01D 53/885; B01D 2255/802; B01D 2257/406; B01D 2257/70; B01D 2255/9202; B01D 2255/20776; B01D 2255/20707; B01D 2255/20738

(57) ABSTRACT

An photocatalytic filter is provided to include a support; and a photocatalytic material coated on the support to cause a photocatalytic reaction to degrade an undesired gas present in an air, and wherein the photocatalytic filter has cells with a width equal to or less than 2 mm, thereby providing an air resistance in a direction facing UV LED for the photocatalytic activation, the air flow having a minimized air resistance.

### CROSS-REFERENCE TO RELATED APPLICATIONS

This application is a continuation-in-part of U.S. patent application Ser. No. 14/871,932, filed Sep. 30, 2015, claims priority to Provisional Application No. 62/057,794 filed on Sep. 30, 2014, and Chinese Patent Application No. 201510096590.7 filed on Mar. 4, 2015. The entire disclosure of the above applications are incorporated by reference in their entirety as part of this patent document.

### TECHNICAL FIELD

The present disclosure relates to a photocatalytic filter and a manufacturing method thereof. Some implementations of the disclosed technology relate to a photocatalytic filter, the surface of which has enhanced adsorption performance so that mixed gases including a gas that reacts later in a competitive reaction can be degraded from the initial stage of a photocatalytic reaction, and to a manufacturing method thereof.

### BACKGROUND

As used herein, the term “photocatalytic reaction” refers to reactions that use photocatalytic materials such as titanium dioxide (TiO₂) or the like. Known photocatalytic reactions include photocatalytic degradation of water, electrodeposition of silver and platinum, degradation of organic materials, etc. Also, there have been attempts to apply such photocatalytic reactions to new organic synthetic reactions, ultrapure water production and the like.

Toxic gases or offensive odor substances, such as ammonia, acetic acid and acetaldehyde, which are present in air, are degraded by the above-described photocatalytic reactions, and air purification devices based on such photocatalytic reactions can be used semi-permanently if they have a light source (e.g., a UV light source) and a filter coated with a photocatalytic material. When photocatalytic efficiency of the photocatalytic filter has reduced, the filter can be regenerated to restore its photocatalytic efficiency, and then it can be reused. Thus, it can be said that the photocatalytic filter is semi-permanent.

Particularly, when a UV LED lamp is used as a UV light source, it is advantageous over a conventional mercury lamp or the like in that it is environmentally friendly because it does not require toxic gas, is highly efficient in terms of energy consumption, and allows various designs by virtue of its small size.

### SUMMARY

Various embodiments provide a photocatalytic filter, which shows a high removal rate of removal of each gas even when mixed gases pass therethrough, and a method for manufacturing the photocatalytic filter, the photocatalyst of which has high adhesion to a base or a substrate.

In some implementations, a method for manufacturing a photocatalytic filter is provided to include: providing a photocatalytic dispersion by dispersing titanium dioxide (TiO₂) nanopowders and metal compounds in water; coating a support with the photocatalytic dispersion; drying the coated support; and sintering the dried support.

In some implementations, wherein the metal compounds include a tungsten (W) compound including atom H. In some implementations, the tungsten (W) compound includes H₂WO₄. In some implementations, the metal compounds include a tungsten (W) compound including H₂WO₄, WO₃, WCl₆, or CaWO₄. In some implementations, the metal compounds include an iron (Fe) compound. In some implementations, the iron (Fe) compound includes Fe³⁺ compound. In some implementations, the iron compound includes FeCl₂, FeCl₃, Fe₂O₃, or Fe(NO₃)₃. In some implementations, the metal compounds include the tungsten (W) compound having a molar ratio between 0.0032 and 0.0064 moles per mole of titanium dioxide. In some implementations, the iron (Fe) compound has a molar ratio between 0.005 and 0.05 moles per mole of titanium dioxide. In some implementations, coating the support includes dip-coating the support. In some implementations, the sintering of the dried support is performed at a temperature between 400° C. and 500° C. for 2 to 3 hours.

In another aspect, a photocatalytic filter is provided to include: a support; and a photocatalytic material and metal compound coated on the support.

In some implementations, the metal compounds include a tungsten (W) compound including H₂WO₄ and an iron (Fe) compound including Fe₂O₃. In some implementations, the photocatalytic material includes titanium dioxide (TiO₂), and the metal compounds include a tungsten (W) compound having a molar ratio between 0.0032 and 0.0064 moles per mole of titanium dioxide. In some implementations, the photocatalytic material includes titanium dioxide (TiO₂), and the metal compounds include an iron (Fe) compound having a molar ratio between 0.005 and 0.05 moles per mole of titanium dioxide. In some implementations, the support includes porous ceramic. In some implementations, the photocatalytic filter comprises a plurality of adjacent parallel cells that form an air flow path in a direction facing UV LED for photocatalytic activation. In some implementations, the photocatalytic filter has a height of 2 to 15 mm. In some implementations, a frame between the cells has a thickness of 0.3 to 1.2 mm. In some implementations, each of the cells has a width of 1 to 4 mm.

### BRIEF DESCRIPTION OF THE DRAWINGS

FIG. 1 shows removal rates of toxic gases as a function of time when using a conventional photocatalytic filter and a photocatalytic filter according to one implementation of the present disclosure.

FIG. 2 is a perspective view showing the arrangement of a photocatalytic filter and a UV LED substrate.

FIG. 3 is a top view of a photocatalytic filter.

FIG. 4 is a graph showing the change in removal rate of acetaldehyde with a change in the height of a photocatalytic filter.

FIG. 5 is a graph showing the change in removal rate of acetic acid with a change in the height of a photocatalytic filter.

FIGS. 6a to 6c show graphs showing removal rates of Toluene, Ammonia, and Acetic acid with a change in a height of the photocatalytic filter exemplarily implemented according to the present disclosure.

FIGS. 7a to 7d show test results on removal efficiencies of an exemplary harmful gas of Acetaldehyde.

### DETAILED DESCRIPTION

Conventional filters such as the pre-filter or HEPA filter physically collect large dust particles when air passes therethrough. Unlike the conventional filters, the photocatalytic filter is configured such that toxic gases adsorbed on the surface of the filter during the passage of air through the filter are degraded by radicals such as OH⁻, generated by the photocatalytic reaction. Thus, toxic gases in air are degraded during the passage of the air through the catalytic filter are not completely degraded, but a portion thereof is degraded. In other words, toxic gases in air are degraded while the air passes several times through the photocatalytic filter.

Thus, the photocatalytic efficiency of the photocatalytic filter is dependent on the air cleaning ability thereof. In other words, toxic gas in a space that uses an air cleaner having high photocatalytic efficiency is degraded faster than toxic gas in a space that uses an air cleaner having the same size and structure, but having a relatively low photocatalytic efficiency.

Meanwhile, it is known that, when air contains a plurality of different toxic gases, the toxic gases are degraded in the order in which they are adsorbed onto the surface of the photocatalytic filter. Thus, among toxic gases, a gas that is adsorbed into the photocatalytic surface at higher rate is degraded faster, and a gas that is adsorbed onto the photocatalytic surface at lower rate is adsorbed and degraded on the photocatalytic surface after the gas adsorbed at higher rate was somewhat degraded.

The deodorization performance test method provided by the Korea Air Cleaning Association includes evaluating the removal rate of a mixture of three gases: acetaldehyde, ammonia, and acetic acid. The results of experiments conducted according to this test method indicated that a commercially available TiO₂ photocatalyst shows a low rate of removal of acetaldehyde among the gases. This is because acetaldehyde reacts later than other gases in a competitive reaction. In other words, the conventional photocatalytic filter is configured such that it degrades a toxic gas that reacts first in a competitive reaction, and then degrades a toxic gas that reacts later.

This propensity of the conventional photocatalytic filter is not desirable from the point of view of air cleaners. In the case of air cleaners that use the photocatalytic reactions, the performance of degrading toxic gases is important, and furthermore, the performance of degrading all types of toxic gases should be excellent, and all types of toxic gases need to be degraded from the initial stage of a photocatalytic reaction.

Exemplary embodiments will be described below in more detail with reference to the accompanying drawings. The disclosure may, however, be embodied in different forms and should not be constructed as limited to the embodiments set forth herein.

The techniques disclosed in this patent document can be used to provide a photocatalytic filter with improved adsorption for acetaldehyde, ammonia and acetic acid gas mixture by introducing metal into titanium dioxide photocatalytic in the filter. An exemplary method for manufacturing the photocatalytic filter with improved adsorption for acetaldehyde, ammonia and acetic acid gas mixture includes providing a photocatalytic dispersion liquid by dispersing titanium dioxide nanopowders and one or more metal compounds in water, coating a photocatalytic support with the photocatalytic dispersion liquid, drying the coated photocatalytic support, and sintering the dried photocatalytic support.

A photocatalytic filter based on the disclosed technology includes a photocatalytic support and a photocatalytic material formed on the photocatalytic support. Under UV light exposure, the photocatalytic material is optically activated to cause a catalytic reaction with one or more targeted contaminants attached to the photocatalytic material coated on the photocatalytic support, e.g., via physical adsorption, therefore removing the contaminants from a gas medium. Targeted contaminants may be microorganisms or other biological material, or one or more chemical substances. A UV light source, such as UV LEDs, can be included to direct UV light to the photocatalytic material formed on the photocatalytic support. Such a photocatalytic filter can be used as an air filter or other filter applications. The photocatalytic material can include, for example, titanium dioxide nanopowders and one or more metal compounds.

A photocatalytic filter according to an embodiment of the present disclosure includes the tungsten (W) and iron (Fe) metal compounds added to a conventional photocatalytic TiO₂ material, and thus shows a high removal rate of mixed gases. In other words, according to the present disclosure, the acidity of the surface of the TiO₂ photocatalyst can be adjusted by adding the metal compounds to the TiO₂ photocatalyst, and thus the ability of the TiO₂ photocatalyst to adsorb gas compounds can be enhanced, thereby increasing the ability of the TiO₂ photocatalyst to remove toxic gas.

Method for Manufacturing Photocatalytic Filter

A method for manufacturing a photocatalytic filter according to the present disclosure is as follows. The method may include the steps of: dispersing photocatalytic TiO₂ nanopowders, a tungsten (W) compound and an iron (Fe) compound in water to prepare a photocatalytic dispersion; coating a porous ceramic honeycomb support with the photocatalytic dispersion; drying the coated support; and sintering the dried support.

As the TiO₂ nanopowder, commercially available Evonik P25 powder may be used.

The W compound that is used in the present disclosure may be H₂WO₄, WO₃, WCl₆, CaWO₄ or the like, and the Fe compound that is used in the present disclosure may be FeCl₂, FeCl₃, Fe₂O₃, Fe(NO₃)₃ or the like. In an exemplary embodiment of the present disclosure, H₂WO₄ is used as the W compound, and Fe₂O₃ is used as the Fe compound.

The reason why H₂WO₄ (tungsten oxide hydrate) among W compounds is used is to introduce WO₃ into the photocatalytic nanopowder. In other words, H₂WO₄ is used as a precursor for introducing WO₃. In other words, in the case in which H2WO4 is introduced as a WO3 precursor, the reactivity between WO3 and TiO2 can be increased by a dehydration reaction compared to the case in which WO3 powder is directly added.

With respect to the Fe compound, Fe²⁺ has an electronic configuration of 1s² 2s² 2p² 3s² 3p⁶ 3d⁶, in which the number of electrons in the outermost shell is greater than half of the valence electrons by one. Also, Fe³⁺ has an electronic configuration of 1s² 2s² 2p² 3s² 3p⁶ 3d⁵, in which the number of electrons in the outermost shell is equal to the number of the valence electrons. Thus, Fe²⁺ has a strong tendency to donate one outermost electron to become relatively stable Fe³⁺ equal to half of the valence electrons. The electron donated from Fe²⁺ as described above reacts with H⁺ produced in the excitation reaction of TiO₂. Thus, when Fe²⁺ is used, the electron donated from Fe²⁺ reacts with H⁺ produced in the excitation reaction of TiO₂, and thus Fe²⁺ is converted into Fe³⁺ which then participates in a photocatalytic reaction. In other words, although Fe²⁺ and Fe³⁺ promote photocatalytic reactions, Fe³⁺ more efficiently promotes the photocatalytic reaction compared to Fe²⁺.

Compounds that are used to introduce Fe into the photocatalytic nanopowder include FeCl₃, Fe₂O₃, Fe(NO₃)₃ and the like. Among these compounds, FeCl₃ and Fe(NO₃)₃ cause a problem during mixing with H₂WO₄, or does not show an increase in photocatalytic activity. However, the results of an experiment indicate that Fe₂O₃ can exhibit a synergistic effect with H₂WO₄. Thus, Fe₂O₃ is preferably used as the Fe compound.

Based on the total moles of TiO₂, H₂WO₄ may be used in an amount of 0.0032 to 0.064 mole %, and Fe₂O₃ may be used in an amount 0.005 to 0.05 mole %. In some implementations, based on the total moles of TiO₂, H₂WO₄ is used in an amount of 0.016 to 0.048 mole %, and Fe₂O₃ is used in an amount of 0.005 to 0.025 mole %.

As the support for the photocatalytic nanopowders, a metal material, activated carbon, a ceramic material or the like may be used. In an exemplary embodiment of the present disclosure, a porous ceramic honeycomb material is used as the support in order to increase the adhesion of the photocatalytic compound. When the porous ceramic honeycomb material is used as the support, the dispersion of the photocatalytic nanopowders penetrates the pores of the ceramic material in the coating step, and the photocatalytic nanoparticles are anchored to the pores after the drying step, thereby increasing the adhesion of the photocatalytic nanoparticles to the ceramic material. If a metal material is used as the support, it will be not easy to attach the photocatalytic nanoparticles to the metal material, compared to attaching the photocatalytic nanoparticles to the ceramic material. In addition, although activated carbon has pores, it can be broken during the sintering step in some cases, and thus the use thereof as the support is undesirable.

In the process of preparing the photocatalytic dispersion, Evonik P25 TiO₂ powder, the W compound and the Fe compound are dispersed using a silicone-based dispersing agent. The silicone-based dispersing agent is used in an amount of 0.1 to 10 wt % based on the total weight of P25 TiO₂ powder, the W compound and the Fe compound. Specifically, 0.1 to 10 wt % of the silicone-based dispersing agent is dissolved in water, and then P25 TiO₂ nanopowder, the W compound and the Fe compound are added to the solution and dispersed using a mill, thereby obtaining a TiO₂ dispersion having a solid content of 20 to 40 wt % based on the weight of the dispersion. Herein, one or more dispersing agents may be used.

In the coating step, a porous ceramic support is dip-coated with the above-prepared photocatalytic dispersion. During the dip coating, the support coated with the photocatalytic dispersion is allowed to stand for 1-5 minutes so that the photocatalytic dispersion can be sufficiently absorbed into the pores of the ceramic material.

In the drying step, the ceramic support coated with the photocatalyst is maintained in a dryer at 150˜200° C. for 3-5 minutes to remove water.

In the sintering step, the photocatalyst-coated ceramic honeycomb support resulting from the drying step is sintered in an electric furnace at 400˜500° C. for 2-3 hours. The results of an experiment indicated that, when the sintering temperature was lower than 300° C., the coated photocatalyst was detached from the support, and when the sintering temperature was between 400° C. and 500° C., the photocatalyst had high adhesion to the support. From the experimental results, it can be seen that the adhesion of the photocatalyst is greatly influenced by the sintering temperature.

Experiment on Removal of Mixed Gases

Using a conventional photocatalytic filter coated with TiO₂ alone, and the photocatalytic filter according to the present disclosure, an experiment on the removal of mixed gases was performed in a 1 m³ chamber. The concentration of each gas in the mixed gases was 10 ppm. The conventional photocatalytic filter and the photocatalytic filter of the present disclosure were each loaded with 2.5 g of the photocatalyst to the support, and were irradiated with UV light using the same UV light source.

The molar ratios between components in the photocatalytic filter according to the present disclosure were as follows: TiO₂/H₂WO₄/Fe₂O₃=1.0/0.032/0.01; TiO₂/H₂WO₄/Fe₂O₃=1.0/0.032/0.015; and TiO₂/H₂WO₄/Fe₂O₃=1.0/0.032/0.02.

The conventional photocatalytic filter coated with TiO₂ alone, and the photocatalytic filter of the present disclosure were tested for their abilities to remove mixed gases. The results of the experiments are shown in Tables 1 and 2 below. As can be seen in the Tables, in the experiment performed using the conventional photocatalytic filter coated with TiO₂ alone for testing removal of mixed gases, acetaldehyde was not removed for 30 minutes after the start of the experiment, and started to be removed after other gases were somewhat removed. However, in the deodorization experiment performed using the photocatalytic filter of the present disclosure, acetaldehyde was removed from the initial stage of the experiment, and the removal rate of ammonia by the photocatalytic filter of the present disclosure was also higher than that that shown by the conventional photocatalytic filter, suggesting that the photocatalytic filter of the present disclosure has an improved ability to remove all the gases.

TABLE 1
Removal rate at 30 minutes after start of reaction

| | | H₂WO₄/ | H₂WO₄/ | H₂WO₄/ |
|---|---|---|---|---|
| Removal | | Fe₂O₃ | Fe₂O₃ | Fe₂O₃ |
| rate (%) | P25—TiO₂ | (0.010)/TiO₂ | (0.015)/TiO₂ | (0.020)/TiO₂ |
| NH₃ | 40 | 52.6 | 70 | 63.2 |
| CH₃CHO | 0 | 20 | 20 | 20 |
| CH₃COOH | 50 | 30 | 50 | 35 |
| Total | 22.5 | 30.7 | 40 | 34.5 |

TABLE 2
Removal Rate at 120 minutes after start of reaction

| | | H₂WO₄/ | H₂WO₄/ | H₂WO₄/ |
|---|---|---|---|---|
| Removal | | Fe₂O₃ | Fe₂O₃ | Fe₂O₃ |
| rate (%) | P25—TiO₂ | (0.010)/TiO₂ | (0.015)/TiO₂ | (0.020)/TiO₂ |
| NH₃ | 55 | 73.7 | 85 | 75 |
| CH₃CHO | 25 | 60 | 60 | 50 |
| CH₃COOH | 85 | 70 | 75 | 60 |
| Total | 47.5 | 65.9 | 70 | 58.75 |

Total removal (%)={(CH₃CHO removal rate)*2+NH₃ removal rate+CH₃COOH removal rate}/4 molar ratio

TiO₂/H₂WO₄/Fe₂O₃=100/10/2 weight ratio (TiO₂/H₂WO₄/Fe₂O₃=1.0/0.032/0.010 molar ratio)

TiO₂/H₂WO₄/Fe₂O₃=100/10/3 weight ratio (TiO₂/H₂WO₄/Fe₂O₃=1.0/0.032/0.015 molar ratio)

TiO₂/H₂WO₄/Fe₂O₃=100/10/4 weight ratio (TiO₂/H₂WO₄/Fe₂O₃=1.0/0.032/0.020 molar ratio).

In addition, from the above experimental results, it can be seen that a photocatalytic filter shows a high removal rate of each gas in mixed gases including three different gases (acetaldehyde, ammonia and acetic acid) and a high adhesion of the photocatalyst to the support, when a photocatalytic filter has a molar ratio of TiO₂/H₂WO4/Fe₂O₃=1.0/0.032/0.015. The temperature for performing the sintering step may be between 400° C. and 500° C.

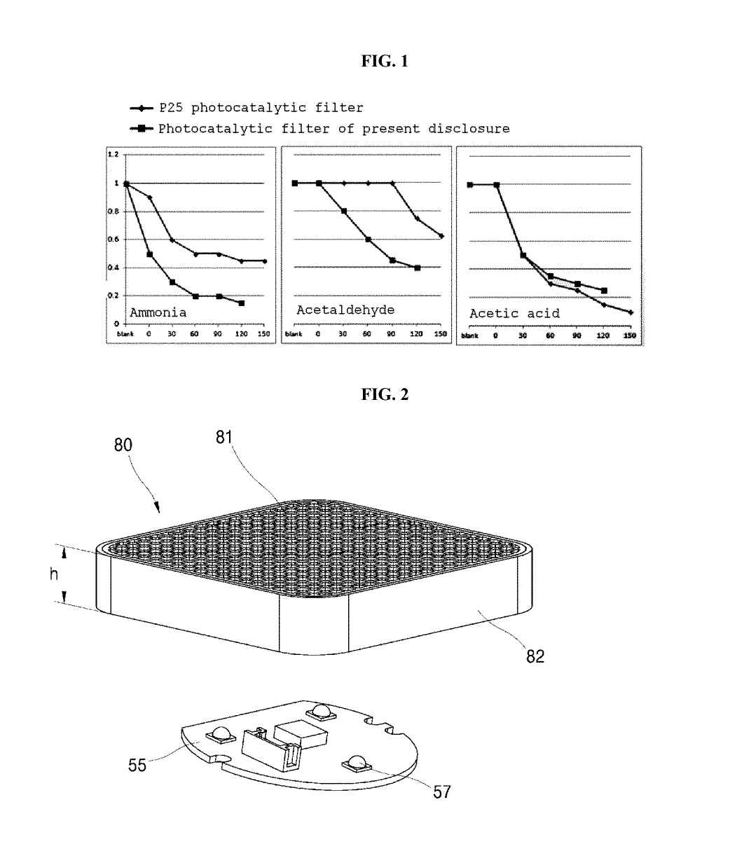

FIG. 1 and Table 3 below show a comparison of deodorization performance between a conventional P25 photocatalytic filter and the photocatalytic filter of the present disclosure, which has a molar ratio of TiO₂/H₂WO₄/Fe₂O₃=1.0/0.032/0.015.

TABLE 3

| | Removal rate (%) | | Removal rate (%) | |
|---|---|---|---|---|
| | after 30 minutes | | after 120 minutes | |
| | P25 | Photocatalytic | P25 | Photocatalytic |
| | photo- | filter of | photo- | filter of |
| | catalytic | the present | catalytic | the present |
| Gases | filter | disclosure | filter | disclosure |
| NH₃ | 40% | 70% | 55% | 85% |
| CH₃CHO | 0% | 20% | 25% | 60% |
| CH₃COOH | 50% | 50% | 85% | 75% |
| Total | 22.5% | 40% | 47.5% | 70% |

As can be seen in Table 3 above and FIG. 1, the photocatalytic filter of the present disclosure, which has a molar ratio of TiO₂/H₂WO₄/Fe₂O₃=1.0/0.032/0.015, has significantly excellent deodorization performance compared to the conventional P25 photocatalytic filter.

As described above, the photocatalytic filter of the present disclosure shows a high removal rate of each gas in the mixed gases including three different gases (acetaldehyde, ammonia and acetic acid). In addition to these gases and combinations of these gases, the photocatalytic filter of the present disclosure is also effective against other gases and combinations thereof if these gases are well absorbed onto the surface of the photocatalytic filter.

As described above, the photocatalytic filter according to the present disclosure shows a high removal rate of each gas in mixed gases.

In addition, according to the method for manufacturing the photocatalytic filter according to the present disclosure, the photocatalyst has high adhesion to the support.

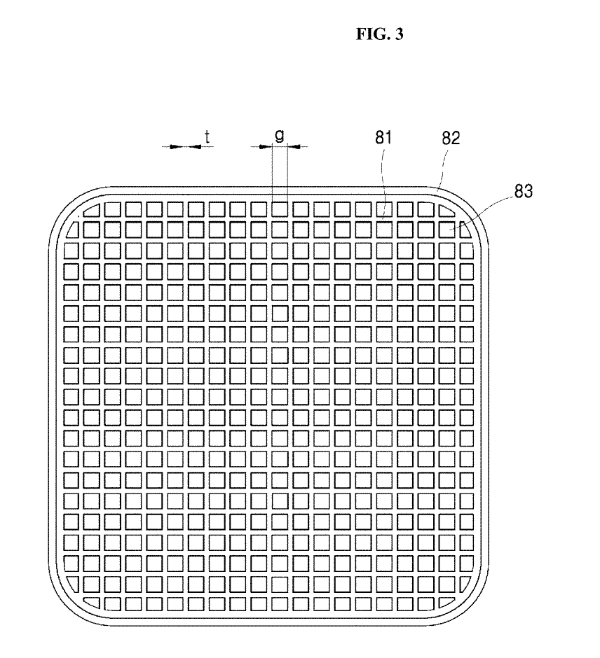

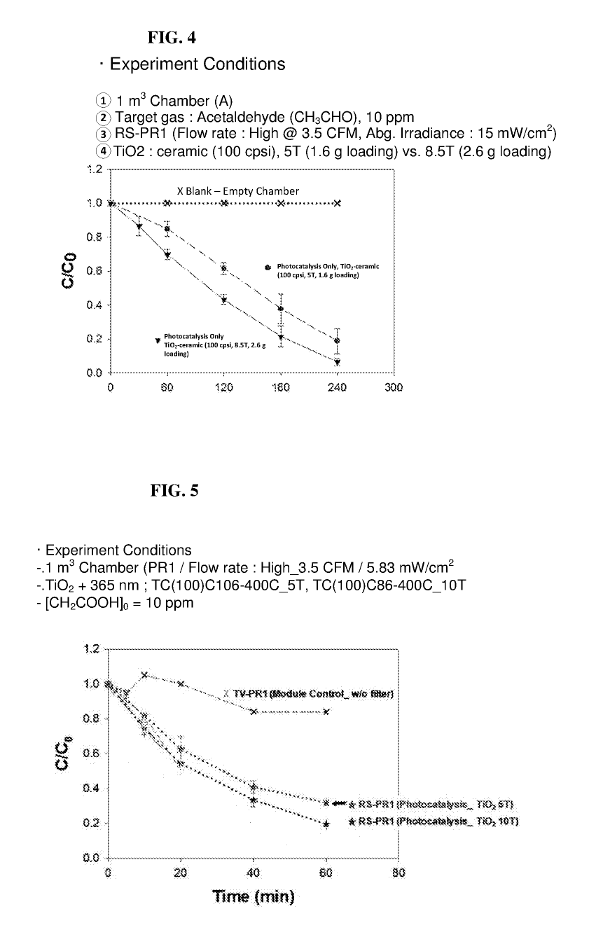

FIG. 2 is a perspective view showing the arrangement of the photocatalytic filter 80 and the UV LED substrate 55, and FIG. 3 is a top view of the photocatalytic filter 80.

Referring to FIG. 2, the UV LED 56 for sterilization is disposed on the central portion of the UV LED substrate 55, and three UV LEDs 57 for photocatalytic activation are disposed around the UV LED 56. For example, the UV LEDs 57 for photocatalytic activation will irradiate UV light toward the photocatalytic filter 80.

As shown in FIG. 3, the photocatalytic filter 80 includes a catalyst portion 81 obtained by sintering TiO₂ (titanium dioxide) coated on a ceramic porous material having a check lattice pattern, and an elastic bumper 82 covering the side of the catalyst portion.

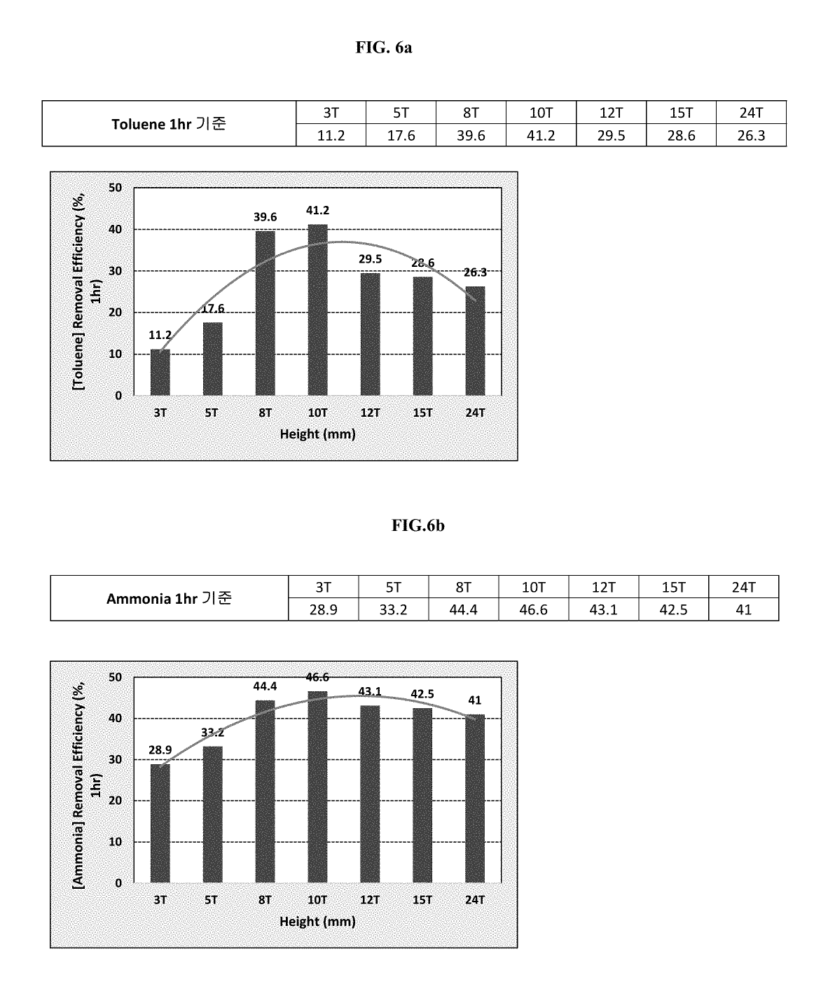

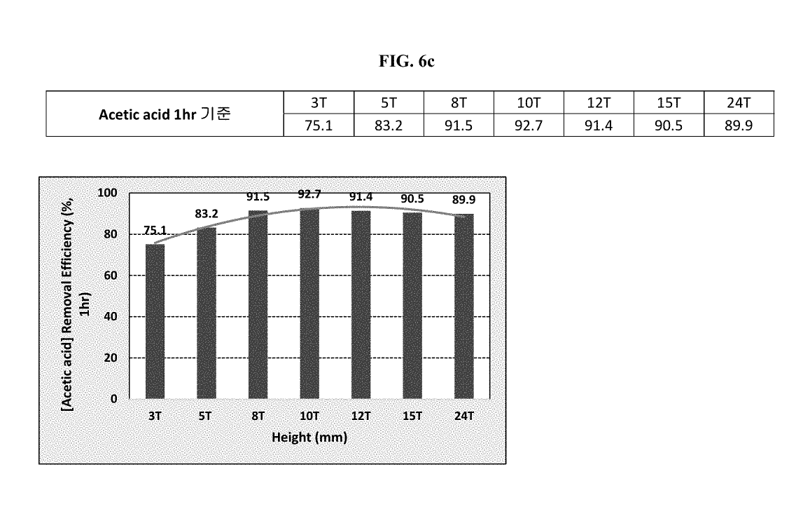

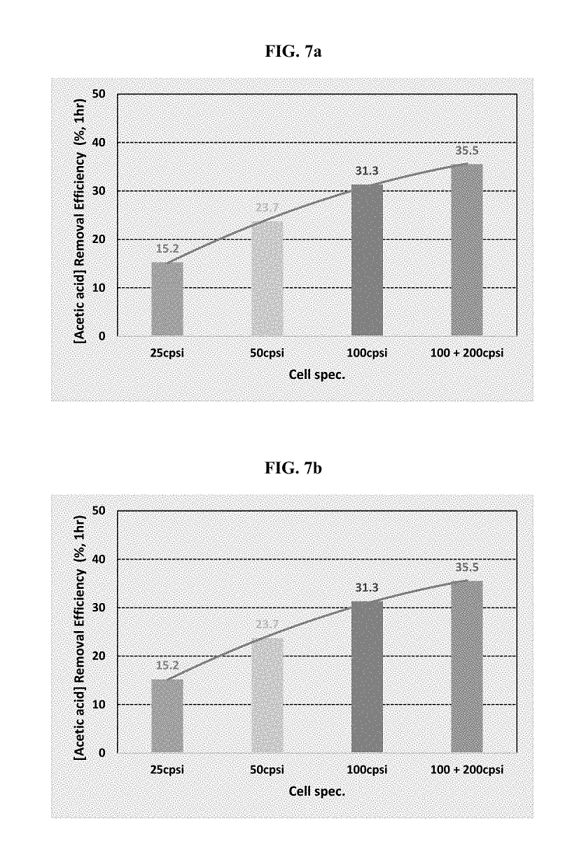

FIG. 4 is a graph showing removal rates of acetaldehyde of two photocatalytic filters that have different height (h), and FIG. 5 is a graph showing removal rates of acetic rate of two photocatalytic filters that have different height (h). FIGS. 6a to 6c show graphs showing removal rates of Toluene, Ammonia, and Acetic acid with a change in a height of the photocatalytic filter exemplarily implemented according to the present disclosure.

The results of the experiment indicated that, in the case of the photocatalytic filter having the shape shown in FIGS. 2 and 3, the surface area of the photocatalyst, which increases due to the thickness (t) of the frame between the cells of the photocatalytic filter, did not substantially influence the deodorization efficiency of the photocatalytic filter, but the height (depth) of the photocatalytic filter influenced the inner wall area of the internal air flow path, thus directly influencing the area of contact with air.

Based on the test results, it could be seen that, when the height of the photocatalytic filter was 5-15 mm, the deodorization efficiency of the photocatalytic filter was the highest. In addition, when the height decreases to 2 mm or less, the photocatalytic filter is difficult to use, due to its weak strength. When the height is 15 mm or more, air resistance increases, UV light does not reach the rear portion of the photocatalytic filter or the intensity thereof becomes very weak, and thus only the cost increases without increasing the deodorization efficiency.

Also, the implementations of the disclosed technology having the desired thickness satisfy industrial standards provided and recommended by Korean Ozone UV Association, which require the deodorization rates of harmful substances for an air purifier or sterilizer to be over 30%. Among the various heights, 3T, 5T, 8T, 10T, 12T, 15T, 24T, the heights of 8T, 10T, 12T satisfy this requirement. The removal rates for Toluene show relatively large variations depending on the height of the photocatalytic filter, while the removal rates for Ammonia and Acetic acid show relatively small variations depending on the height of the photocatalytic filter. Although the removal rates for the height 12T are shown as 29.5%, the height 12T can be deemed to satisfy the 30% requirement in light of an error margin depending on various situations for a test.

Also, it could be seen that, when the width (g) of each cell 83 was 2 mm, the air resistance did not increase, and the rate of shadowed area of the inner wall of the photocatalytic filter, which is generated by the shape of the filter itself blocking UV light irradiated thereto, was not high, suggesting that the cell width of 2 mm is most suitable for maximizing the rate of UV light irradiated area of the inner wall of the photocatalytic filter. When the cell width was 4 mm or more, the whole area of the inner wall decreased due to low cell density, suggesting that the efficiency of deodorization was low.

Regarding the density of cells in view of width (g) of each cell above mentioned, when the density of cells was lower than 30 cells/inch² or less, that is the cell width increased to 4 mm or more, the area of the inner wall decreased, indicating that the efficiency of deodorization was low. When the density of cells was 260 cells/inch² or more, that is the cell width decreased to 1 mm or less, the air resistance increased and the amount of UV light reaching the inner wall decreased, indicating that the efficiency of deodorization was low. When the density of cells was about 100 cells/inch², the air resistance did not increase, and the rate of shadowed area of the inner wall of the filter, which is generated by the shape of the filter itself blocking UV light irradiated thereto, was not high, suggesting that the efficiency of deodorization was the highest.

The results of an experiment on the thickness (t) of the cell frame indicated that, when the frame thickness was 0.3 mm or less, the TiO₂ layer became too thin, and thus the photocatalytic efficiency decreased and the strength was insufficient. When the frame thickness was 1.2 mm or more, the material cost increased without increasing the photocatalytic efficiency. In addition, the photocatalytic efficiency was the highest when the frame thickness was 0.6 mm.

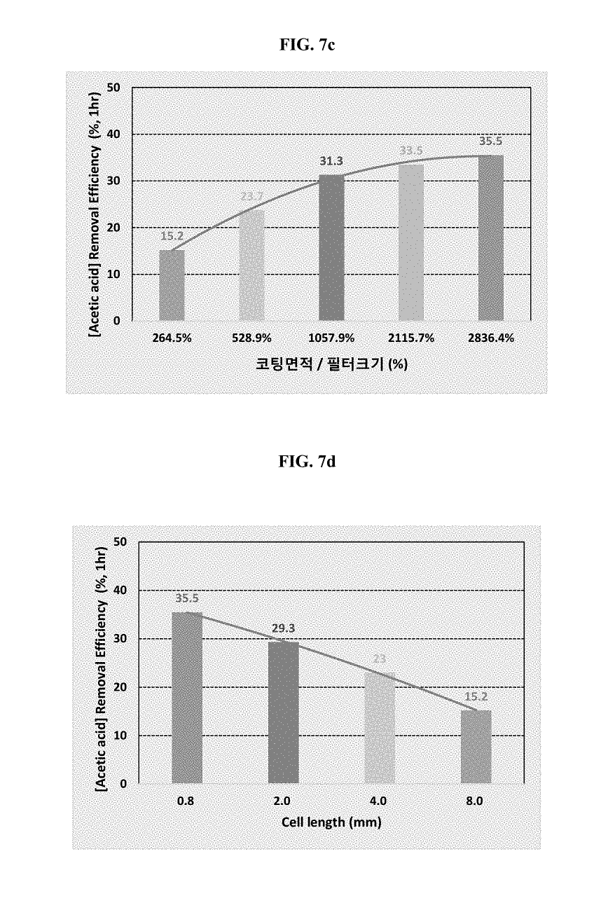

FIGS. 7a to 7d show test results on removal efficiencies of an exemplary harmful gas of Acetaldehyde. To conduct the test, various factors of a photocatalytic filter are varied by using cells with different specifications. Cells with different specifications, for examples, 100 cpsi and 200 cpsi, are available in the market. The cells with the specifications which are used in the test but are not available in the market, for example, 25 cpsi, 50 cpsi, are prepared by selectively overlapping the available cells. The cell specification 100 cpsi ×2 indicates two overlapping 100 cpsi cells. The cell specification 100+200 cpsi indicates 200 cpsi cell and 100 cpsi cell that are overlapping each other.

Table 4 below shows the test results of removing rates of Acetaldehyde at 1 hour after the start of the test.

TABLE 4
Removal Rate At 1 Hour After Start of Test

| | Cell Specification | | | | |
|---|---|---|---|---|---|
| | 25 | 50 | 100 | 100 | 100 + 200 |
| | cpsi | cpsi | cpsi | cpsi × 2 | cpsi |
| TiO₂ Coating | 80 | 160 | 320 | 640 | 858 |
| Area (cm²) | | | | | |
| Percentage of | 264.5% | 528.9% | 1057.9% | 2115.7% | 2836.4% |
| Coating Area | | | | | |
| over Filter | | | | | |
| Area (%) | | | | | |
| Cell Width (mm) | 8 | 4.0 | 2.0 | 2.0 | 0.8 |
| Air Velocity | 1.5 | 1.32 | 1.25 | 1.23 | 1.05 |
| (m/s) | | | | | |
| Removal Effi- | 15.2 | 23.7 | 31.3 | 33.5 | 35.5 |
| ciency (%) | | | | | |

By using different cells, TiO₂ coating area, a ratio between the TiO₂ coating area and filter size, and a cell width of the photocatalytic filter are varied. The test results in FIG. 7a show the cell specifications having 100 cpsi and 100 cpsi+200 cpsi have removal efficiencies over 30%. The test results in FIG. 7b show that as the TiO₂ coating area increases, the removal efficiencies increase. Please note that the removal efficiencies do not increase in a linear proportion to increasing the area of the TiO₂ coating. Despite the increase of the TiO₂ coating area, the removal efficiencies of the filter does not increase as much as the increase in the TiO₂ coating area since the smaller cell size increases an air velocity passing through the filter. Table 4 above shows that the air velocity decreases as the cell size becomes smaller. Based on FIG. 7c, when the coating area is greater than 10 times of the filter size, the removal efficiencies become higher than 30%. The filter size mentioned can be decided depending on the filter type as shown in the table below.

TABLE 5
Data on Filter and Cell Properties

| | TiO2 | Filter | Cell | Aperture | Test Air | Filter Face |
|---|---|---|---|---|---|---|
| Module | Filter | Size | Area | Ratio | Volume | Velocity |
| Type | (mm) | (mm2) | (mm2) | (%) | (m³/min) | (m/s) |
| Fridge | 33 × 33 | 1,089 | 676 | 62.1% | 0.17 | 4.19 |
| P-AP | 55 × 55 | 3,025 | 1,600 | 52.9% | 0.08 | 0.83 |
| Fridge | 55 × 55 | 3,025 | 1,600 | 52.9% | 0.17 | 1.77 |
| | | | | | 0.30 | 3.13 |
| | | | | | 0.41 | 4.27 |
| Mid-sized | 75 × 75 | 5,625 | 3,364 | 59.8% | 3.53 | 4.37 |
| Compact | 100 × 100 | 10,000 | 7,569 | 75.7% | 1.30 | 2.86 |
| Meiling | 100 × 40 | 4000 | 2340 | 58.5% | 0.33 | 2.35 |

When a filter size is fixed, if a cell width becomes smaller, there are more cells included in the filter, which makes the TiO₂ coating area greater. Based on the results shown in FIG. 7d, when the cell width is not greater than 2 mm, the removal efficiency is above 29%. In light of an error margin, the cell width not greater than 2 mm satisfies 30% removal efficiency of Acetaldehyde. Based on the result, the photocatalytic filter may be designed such that each cell extends no more than 2 mm in a two-dimensional horizontal and vertical directions.

The results in Table 4 above show that, to improve and optimize the filter efficiency, the increase of the TiO₂ coating area needs to be limited in consideration of the air velocity. The increase of the TiO₂ coating area also has some limitations in terms of difficulties of the fabrications, increase in costs, etc. The manufacturing process for the photocatalytic filter would become more difficult as more cells are included in a limited area.

The disclosed technology provides various considerations to provide the photocatalytic filter exhibiting desirable removing rates of harmful gases. Based on the disclosed technology, the photocatalytic filter can be specifically designed to improve its performance.

While various embodiments have been described above, it will be understood to those skilled in the art that the embodiments described are by way of example only. Accordingly, the disclosure described herein should not be limited based on the described embodiments.

What is claimed is:

1-20. (canceled)

21. A photocatalytic filter including:
a support; and
a photocatalytic material coated on the support to cause a photocatalytic reaction to degrade an undesired gas present in an air, and
wherein the photocatalytic filter has cells with a width equal to or less than 2 mm, thereby providing an air resistance in a direction facing UV LED for the photocatalytic activation, the air flow having a minimized air resistance.

22. The photocatalytic filter of claim 21, wherein the minimized air resistance is not greater than 1.32 m/s.

23. The photocatalytic filter of claim 21, wherein the minimized air resistance is between 1.05 m/s and 1.25 m/s.

24. The photocatalytic filter of claim 21, wherein the photocatalytic material includes titanium dioxide (TiO₂).

25. The photocatalytic filter of claim 21, wherein the photocatalytic filter has a height between 5 mm to 12 mm.

26. The photocatalytic filter of claim 21, wherein the photocatalytic filter allows a first undesired gas that reacts later than a second undesired gas in a competitive reaction is degraded from an initial stage of the photocatalytic reaction.

27. The photocatalytic filter of claim 21, wherein the support is further coated with metal compounds.

28. The photocatalytic filter of claim 27, wherein the photocatalytic filter exhibits a higher removal rate of the undesired gas as compared to a photocatalytic filter without including the metal compounds.

29. The photocatalytic filter of claim 27, wherein the metal compounds include a tungsten (W) compound including H₂WO₄.

30. The photocatalytic filter of claim 29, wherein the tungsten (W) compound has a molar ratio between 0.0032 and 0.0064 moles per mole of titanium dioxide.

31. The photocatalytic filter of claim 27, wherein the metal compounds include an iron (Fe) compound including Fe₂O₃.

32. The photocatalytic filter of claim 31, wherein the iron (Fe) compound has a molar ratio between 0.005 and 0.05 moles per mole of titanium dioxide.

33. The photocatalytic filter of claim 31, wherein the Fe₂O₃ causes an increase in the photocatalytic reaction as compared to FeCl₃ and Fe(NO₃)₃.

34. A photocatalytic filter including:
a support; and
a photocatalytic material coated on the support to provide a coating area causing a photocatalytic reaction to degrade an undesired gas present in an air, and
wherein the coating area has a size greater than 10 times of a size of the filter.

35. The photocatalytic filter of claim 34, wherein the photocatalytic material includes titanium dioxide (TiO₂).

36. The photocatalytic filter of claim 34, wherein the photocatalytic filter has a height between 5 mm to 12 mm.

37. The photocatalytic filter of claim 34, wherein the support is further coated with metal compounds including a tungsten (W) compound including H₂WO₄ and an iron (Fe) compound including Fe₂O₃.

38. The photocatalytic filter of claim 34, wherein the photocatalytic filter has cells with a width equal to or less than 2 mm, thereby providing an air resistance in a direction facing UV LED for the photocatalytic activation, the air flow having a minimized air resistance.

39. The photocatalytic filter of claim 39, wherein the minimized air resistance is not greater than 1.32 m/s.

40. A photocatalytic filter including:
a support; and
a photocatalytic material coated on the support to provide a coating area causing a photocatalytic reaction to degrade an undesired gas present in an air, and
wherein the photocatalytic filter has a height between 8 to 12 mm.

39. The photocatalytic filter of claim 38, wherein the photocatalytic material includes titanium dioxide (TiO₂).

40. The photocatalytic filter of claim 38, wherein the support is further coated with metal compounds including a tungsten (W) compound including H₂WO₄ and an iron (Fe) compound including Fe₂O₃.

41. The photocatalytic filter of claim 40, wherein the photocatalytic filter has cells with a width equal to or less than 2 mm, thereby providing an air resistance in a direction facing UV LED for the photocatalytic activation, the air flow having a minimized air resistance.

42. The photocatalytic filter of claim 41, wherein the minimized air resistance is not greater than 1.32 m/s.

43. The photocatalytic filter of claim 40, wherein the photocatalytic material provides a coating area on the support having a size greater than 10 times of a size of the filter.
